(19) United States
(12) Patent Application Publication
(10) Pub. No.: US 2004/0267584 A1
(43) Pub. Date: Dec. 30, 2004

(54) System and method for computational organizational model of focused activity systems

(76) Inventor: Steven R. Corman, Chandler, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/877,115

(22) Filed: Jun. 25, 2004

Related U.S. Application Data
(60) Provisional application No. 60/482,530, filed on Jun. 25, 2003.
(60) Provisional application No. 60/482,479, filed on Jun. 25, 2003.
(60) Provisional application No. 60/482,547, filed on Jun. 25, 2003.

(51) Int. Cl. G06F 17/60

(52) U.S. Cl. 705/7

(57) ABSTRACT

A complex system has foci representing activities within the complex system. The foci can represent functions within a commercial business. Each of the foci have interdependency relationships including compatible interactions, incompatible interactions, and no interaction between the foci. The interdependency relationships are represented as links between the foci. The links are coded to indicate magnitude and sign of each interdependency relationship. A model of activity levels of the foci is provided which is based on the interdependency relationships. The model is defined in part by A_{f,t-0}=E_{f,t-0}+c_{f}A_{f,t-1}−n_{f}O_{f,t-1}+ε. The model is represented graphically as activation levels over time. The model provides a means of managing the foci to alter the operation of the complex system by adjusting at least one of the foci.

### CLAIM TO DOMESTIC PRIORITY

The present invention claims priority to the following provisional patent applications: 60/482,530, “Computational Organizational Model of Focused Activity in a Grocery Store Chain” filed Jun. 25, 2003; 60/482,479, “Using Activity Focus Networks to Pressure Terrorist Organizations” filed Jun. 25, 2003; and 60/482,547, “Network Dynamics in Self-Organizing Communication and Activity Systems” filed Jun. 25, 2003.

### FIELD OF THE INVENTION

The present invention relates in general to computer modeling and, more particularly, to a system and method for using a computational organizational model of focused activity systems.

### BACKGROUND OF THE INVENTION

The field of complex systems generally relates to systems which receive many inputs and perform computations and decision analysis to generate one or more outputs. The inputs can take any form or relationship, e.g., random, sequential, independent, correlated, or uncorrelated. The system itself may contain a great number of interconnected processing nodes or elements. While the inputs may be independent, there is usually some interdependence within the system, i.e., the result of one processing node feeds another processing node. Examples of complex systems include biological organisms, financial markets, business organizations, decision trees, ecosystems, computer programs, and manufacturing systems. The typical complex system is a closely connected web of interacting elements each receiving one or more inputs, operating from their own schema or local knowledge, and providing one or more outputs. Such systems are usually nonlinear, dynamic, adaptive, and ubiquitous. Complex systems represent a useful tool in describing, modeling, and understand the natural order of things.

There can be little doubt about the importance of communication and activity in explanations of organizational phenomena. Complex systems are useful in explaining and understanding relationships and communications within organizations. Complex systems can help explain certain complex and distributed events such as shared understanding, informal structure, and inter-subjectivity. One example is reticulation theory, which proposes that organizational communication can best be explained in terms of three meso-level modalities of structure: reticulation, activation, and enactment. Each modality represents a meaningful way in which one domain is mapped to the other in a continuing process of production and reproduction. The reticulation modality explains how an abstract network of perceived relationships is produced and reproduced in instances of observable communication and interaction between members of the network. The activation modality explains how abstract activity foci are produced and reproduced in manifest activities that organize network members. The enactment modality explains how conventions for coding organizational inputs are produced and reproduced in encoded triggering events. The enacted events trigger activation, generates focused activity, and creates the impetus and context for reproduction of the network in observable communication. The communication is one side of a complex system of interaction between the modalities of enactment, activation, and reticulation.

In understanding a complex system, it is difficult to convert such theories into practical analysis tools. In the reticulation example, one side of each modality involves events in the domain of social interaction. The events are difficult to observe in such a scale that is appropriate for studying organization-level communication processes. The events may not be easily separated from phenomena in the domain of social structure, because one constitutes the other in a system of production and reproduction. The ability to make comprehensive observations of everything that happens in organizations, especially for the span of time that would be necessary to see a perceived network change in response to manifest communication events in the context of focused activity, remains elusive. It is one thing to say, at an abstract level, that communication networks are produced and reproduced in interaction processes. It is quite another to say how that might work out in practice, to reliably observe it and test the claim that it happens.

One analysis tool which has been used in business organization and operational research is known as a directed acyclical graph (DAG). The DAG contains process flow with a certain number of interconnected events or states in the process. The interconnecting lines are the tasks which can be weighted in terms of time and complexity. The model helps identify and analyze one or more critical paths which constrains the process flow. The DAG flow is one directional in that no state can loop back on a previous state, i.e., time cannot be repeated.

### SUMMARY OF THE INVENTION

In one embodiment, the present invention is a computer implemented method of modeling a complex system, comprising providing a complex system having foci representing activities within the complex system, providing interdependency relationships between the foci, providing a model of activity levels of the foci based on the interdependency relationships, and managing the foci to alter the operation of the complex system.

In another embodiment, the present invention is a method of using a model of a complex system comprising providing a model of a complex system having foci representing activities within the complex system, wherein the model is based on interdependency relationships of the foci, providing activation triggering events to exercise the foci, and managing reaction of the foci to the activation triggering events to alter the operation of the complex system.

### BRIEF DESCRIPTION OF THE DRAWINGS

FIG. 1 is a block diagram of a computer system for executing the computational organizational model;

FIG. 2 illustrates a complex network of a grocery store operation with interrelationships between network foci;

FIGS. 3a-3c are plots of activation levels of the network foci;

FIGS. 4a-4b are plots of activation levels of the network foci;

FIGS. 5a-5c are plots of activation levels of the network foci;

FIG. 6 illustrates series variances between the network foci;

FIG. 7 is a table of structured triggering events in the grocery store over multiple weeks;

FIG. 8 is a complex network of a terrorist organization with interrelationships between network foci;

FIGS. 9a-9f are plots of activation levels of the network foci;

FIG. 10 illustrates steady-state versus accumulation mode in the terrorist model;

FIG. 11 illustrates increased system activation due to increased carryover in the terrorist network foci;

FIGS. 12a-12b illustrate before and after networks under high decay, high initial density, and high capacity;

FIGS. 13a-13b illustrate before and after networks under low decay, low capacity settings;

FIG. 14 illustrates three modes of reproduction in the reticulation simulation; and

FIG. 15 illustrates a process of modeling a complex system.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Complex systems can be used to describe the relationships and behavior involved in many modern commercial organizations. Complex systems also relate to areas such as biological organisms, financial markets, decision trees, ecosystems, computer programs, business operations, and manufacturing systems. The complex system can be described as a closely connected web of interacting elements each receiving one or more inputs, operating from their own schema or local knowledge, and providing one or more outputs. Such systems are usually nonlinear, dynamic, adaptive, and ubiquitous. Complex systems represent a useful tool in describing, modeling, and understand the natural order of things.

The present discussion considers ways of modeling the interaction of complex systems of activity foci. The process involves describing activity foci in a particular organization and identifying relationships between them. Activity foci have a recognizable pattern of compatibilities and incompatibilities. In the model, activation induced in foci by triggering events is dissipated as activities associated with the foci take place. However, the ability of a focus to generate activity, and thus dissipate its activation, is influenced by activation in other compatible and incompatible foci. The result is a system that under some circumstances shifts into a far from equilibrium (FFE) state where it steadily accumulates activation.

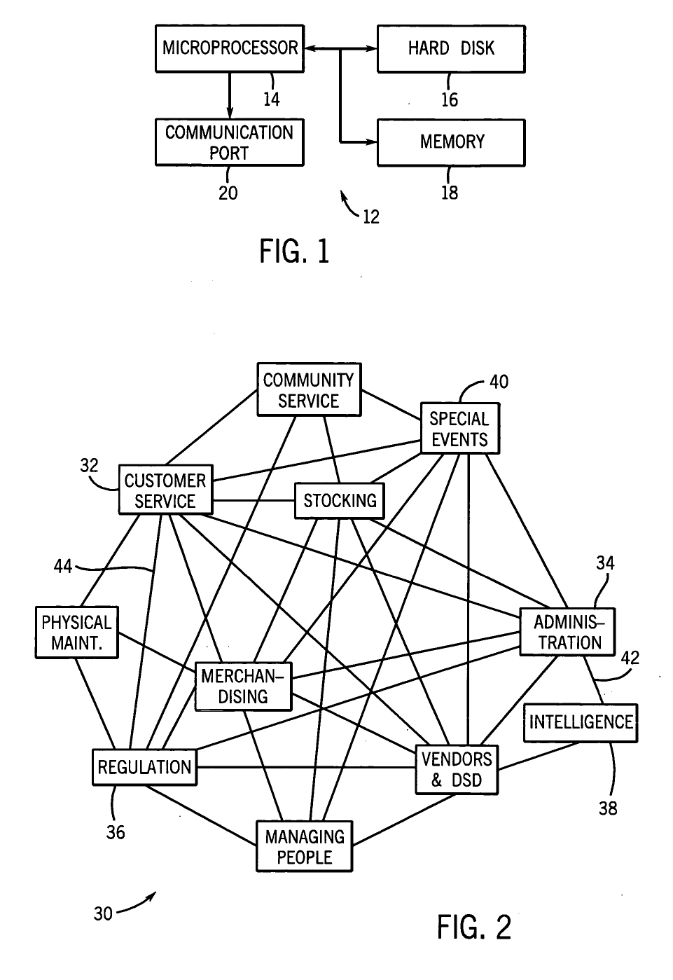

A general purpose computer 12, as shown in FIG. 1, includes central processing unit or microprocessor 14, mass storage device or hard disk 16, electronic memory 18, and communication port 20. Computer 12 uses hard disk 16 for storing modeling data. In one embodiment, the computational organizational model is application software or computer programs residing on computer 12. The software is originally provided on computer readable media, such as compact disks (CDs), or downloaded from a vendor website, and installed on the computer. In one case, the model can be executed directly on computer 12. Alternatively, the user accesses the model remotely, e.g., through communication port 20 to a website contained on hard disk 16.

To assist in explaining the model, the complex system is considered in terms of the operations of a grocery store within a food store chain. The grocery store is a complex system in terms of its many interdependent and independent activities occurring over the course of one or more business days. Merchandise must be ordered and received in the back of the store. The shelves must be stocked, displays built, and prices for products set and confirmed. Customer must be serviced by directing them to merchandise, answering questions, responding to complaints, and check-out. Daily store administration must be completed, cash deposited, and work schedules set. Much of the activity within the grocery store is handled by people. The dynamics of employee management figures into the complex system. Resources must be allocated and problems solved as each arises.

Certain activity functions or states (foci) involved in the day-to-day events or activities in the store are considered: administration, managing people, merchandising, stocking, customer service, community service, vendors and direct store deliveries (DSD), regulation, special events, physical maintenance, and competitive intelligence. Administration involves discharging contractual and legal obligations, and providing routine accountability to corporate and other organizations. Specific activities include data collection and analysis, reporting, forms-processing, voice-mail, administrative paperwork, scheduling, payroll, store security, enforcing policy, and inventory. Managing people involves maintaining personal and professional relationships with employees such as meetings, performance appraisals, discipline, and recognizing birthdays. Merchandising involves enhancing the appeal of merchandise, e.g., displaying merchandising kits, getting product onto the floor, fronting shelves, and keeping the store's shopable appearance. Stocking involves getting merchandise into the store and onto the shelves, e.g., unloading trucks, checking-in merchandise, and stocking shelves. Customer services involves meeting needs of customers, e.g., responding to customer complaints, working the registers, handling special orders, lotto sales, video counter sales, and getting customers in and out of the store.

Community services involve promoting a positive relationship between the store and surrounding community, e.g., donating items to community fundraisers, and sponsoring and participating in community events. Working with vendors and DSD involves facilitating vendor maintenance of their wares, e.g., handling direct store deliveries. Regulations involve complying with government regulations, e.g., health inspections, liquor policy enforcement, recalls, and dealing with other legal matters. Special events involve orienting store operations toward celebrations in the surrounding community, e.g., holiday displays, decoration, ordering, selling tickets for local events, and participating in event activities. Physical maintenance involves insuring the integrity of the store's physical plant, e.g., fixing broken equipment and cleaning the physical plant. Competitive intelligence involves gathering information about the actions of competitors, e.g., visiting other stores and talking to other store managers.

In FIG. 2, the above-described activity foci are shown within complex network 30. The network foci are shown for example as blocks 32, 34, and 36, representing customer service, administration, and regulation, respectively. Each foci within complex network 30 has connections or links to other foci. Customer service block 32 is connected to administration block 34 and to regulation block 36. Likewise, administration block 34 is connected to regulation block 36 and to competitive intelligence block 38. The links can be color coded or shaded to identify the sign and magnitude of the interdependency. Not all foci are directly connected to other foci. Customer service block 32 is not directly connected to competitive intelligence block 38. Regulation block 36 is not directly connected to special events block 40. Consequently, there are no dependencies between these blocks.

The links or connections represent relationships and interdependencies between the network foci. The interdependencies can be positive or negative, compatible or incompatible. The magnitude of the interdependencies can be expressed in absolute form such as +1 or −1, or as a real number such as +10 or −0.85. Link 42 between administration block 34 and competitive intelligence block 38 may be +1. Link 44 between customer service block 32 and regulation block 36 may be −1. The lack of connection indicates independence, unrelated, or substantially zero interdependency between the respective foci.

The compatibilities and incompatibilities between the foci affect the function of complex network 30. Compatible foci (positive numbers) are ones that organize the same or similar activities, or somehow reduce the time and effort associated with or between common activities. If a special events focus is activated, one resulting activity might be setting up store displays. The things done to set up displays are also related to and reduce the time and effort involved in the merchandising and stocking, so those foci are compatible with special events. Likewise, stocking and merchandising are compatible because they can be done simultaneously and/or utilize similar base activities. The dissipation of the activities complement one another.

On the other hand, incompatible foci (negative numbers) are ones having activities which are competing or mutually exclusive, such that doing activities associated with one precludes or interferes with doing activities associated with the other. If a government regulation focus is activated by, say, a surprise health department inspection, nearly exclusive attention must be devoted to activities surrounding such an exigency. Resources that might normally be allocated to activities like dealing with vendors or handling personnel issues may be dropped or delayed. Other combinations, like administration and customer service, are incompatible because time and resources devoted to administration tend to detract from customer service duties and visa versa. Other foci, like community service and competitive intelligence, are not significantly related. The relationships between network foci place constraints on how complex system 30 can structure activity in order to achieve an efficient mode of operation.

A matrix of compatibilities can be constructed and coded between each of the foci of complex network 30. Within the matrix, a positive “+” sign or positive number would indicate a compatible relationship, a negative “−” sign or negative number would indicate an incompatible relationship, and a zero or blank would indicate independence or unrelated, i.e., neither compatible or incompatible, between the foci. The foci, compatibility data, and triggering events are the basis for a model of activation in the grocery store. The trigger events of the foci can be determined from historical data and interviews with store managers and employees. The model assumes that when triggered activity foci attain activation, which is a potential of foci to organize activities associated with them. When the activities take place, activation is dissipated, i.e., the activities get done over time. A focus can dissipate only so much activation in a given time period, and new triggering events may occur to reactivate the focus at any time. Thus, the activation process can be explained as a time series or autoregressive process, where the current value of activation for a focus is composed of activation carried over, i.e., not dissipated in the last time period, plus fresh inputs of triggering events.

Given a finite amount of activity the store can generate, dissipating activation in one focus could be impaired by activation in an incompatible focus. On the other hand, dissipation may be accelerated if compatible foci are co-activated. Therefore, an additional term is added to the basic time series that increases or decreases an activation of a focus based on the activation of compatible and incompatible foci at the previous time step.

The model generates activation levels for each focus for each time period in the simulation. The activation levels are combined with assumptions about who is activated by the various foci, how these people are related to one another, and assumptions about relationship formation, maintenance, and disengagement. One significant triggering event is the arrival of delivery trucks from the corporate warehouse carrying merchandise for the store. When a truck arrives, the stocking and merchandising foci are activated, people associated those foci start doing their jobs, and they communicate as a consequence. As they communicate, members” perceived relationships change, hopefully strengthening slightly because they have been reproduced in the context of the joint activity.

In this context, the model uses two functions. The social activation function maps the activated foci onto the network of perceived relationships to cause dyads to communicate. Larger groupings are treated as collections of dyads. The social cognition function operates on such instances of communication to modify the perceived communication relationships for the next cycle.

When triggered, the foci give rise to activities in the domain of social interaction that involve store managers and other employees. In this way the foci promote (and/or constrain) manifestation of the perceived network relationships between store employees in observable communication. Foci also have a tendency to promote new relationships between the people they organize, so they are also a source of change in the stores” networks of perceived relationships.

Therefore, understanding the dynamics of the activation modality is useful to research applications of reticulation theory. The foci are triggered by very different kinds of events. The special events focus is primarily triggered in an annual cycle by dates on the calendar, e.g., holidays, civic celebrations. Foci like customer service, stocking, and merchandising are triggered in daily or weekly cycles by arrival of customers, and delivery of stock and materials. The administration focus may be triggered monthly by more abstract reporting deadlines and events at corporate headquarters. Because there are multiple foci in the store, people can be activated by more than one focus at a time, and may be more or less activated by any given focus. So activation is a feature or property of both the activity system and the people who are doing the activity, as depicted in FIG. 2.

In defining the computational organizational model to explore the systemic features of the activity foci, the foci are conceptualized as deactivation structures that absorb enacted triggering events and generate activity. The rules that govern the interaction of the foci over time are specified. The operation of the model is then analyzed with sets of triggering events.

In order to understand how foci organize activity, it is necessary to conceptualize them in terms other than the activity they supposedly organize. The concept of activation is used to describe the dynamic potential of foci to organize their associated activities. Activation is something akin to inertia, and is caused by triggering events associated with the focus. Activated foci have an imperative quality, generating pressure for the system to perform activities to dissipate the activation.

The activation of a focus corresponds to its organizing influence on associated activities. In the grocery store, an example of the imperative nature of activation would be a major holiday triggering the special events focus. When a planning date associated with a major holiday arrives, the store must generate a number of activities over an extended period of time. Orders must be placed, extra workers must be scheduled, merchandise must be moved around or put into storage, displays must be constructed, contingencies associated with all those activities must be handled, and so on. Once a display is constructed, it does not need to be moved again, until some other seasonal or holiday trigger comes along. Thus, the activation associated with the focus is dissipated when people in the store engage in and complete the requisite activities.

Conceptualizing foci as deactivation structures implies the operation of a process that converts activation into activity. As activities are the things dissipating activation in the model, it follows that deactivation takes time as well. The deactivation rate is the proportion of its activation a focus can dissipate in a period of time, e.g., over one or more days. The deactivation rate can vary from 0 (no dissipation in a day) to 1 (complete dissipation in a day). Where the deactivation rate is less than 1, activation is not completely dissipated in one day and remains to be dissipated on subsequent days. Carryover is simply the opposite of dissipation; that is, if one day a focus is activated by 100 units and has a dissipation rate of 0.7, then the carryover to the next day(s) would be 30 (100−0.7*100), and the carryover rate would be 0.3.

Besides dissipation of activation, time also brings the occurrence of new triggering events. Therefore, the dissipation of activation from the previous period, if any has been carried over, and additional activation caused by new triggering events must be taken into account. The non-interactive portion of the model is defined in equation (1) in terms of an autoregressive process as:

A_{f,t-0}=E_{f,t-0}+c_{f}A_{f,t-1}+ε (1)

where:

A_{f}=activation of a focus

c_{f}=carryover rate of the focus (1−deactivation rate)

E_{f}=magnitude of a triggering event associated with the focus, expressed in the same units as A

ε=error

In other words, the present activation is a combination of current triggering events, plus carryover from prior time, plus error. Foci have their own trajectory for dissipating activation, as represented in equation (1). But foci do not dissipate their activation in isolation. Rather, foci are part of a network of interfocus influence, and the effects of neighboring foci (other foci to which a given focus is linked) must be taken into account. Some foci are compatible, some are incompatible, and others are unrelated. Unrelated foci do not influence one another. However, the relations of compatibility and incompatibility in the model must be taken into account.

As stated, compatible foci are ones that activate the same or similar activities, reducing the time and effort associated with common activities. For a given focus in a given day, compatible neighbors help a focus dissipate more activation than would be the case if a focus are operating in isolation, thereby reducing carryover. Incompatible foci, on the other hand, are ones whose activities are competitive or mutually exclusive, such that doing activities associated with one precludes or interferes with doing activities associated with the other. So for a given focus on a given day, incompatible neighbors interfere with the dissipation a focus would have achieved had it been operating in isolation, thereby increasing carryover.

The activation level of the various foci represents their organizing influence. For a given focus at a given time, neighbor influence is represented as a weighted sum of the activation levels of other foci to which the given focus is related. Other activation is defined in equation (2) as:

O_{f,t-1}=Σ_{i≠f}(m_{i,f}·A_{i,t-1}) (2)

where:

O_{f}=other activation with respect to focus f

m_{i,f}=compatibility of foci i and f

Aᵢ=activation of focus i

Cells in the compatibility matrix c can have the values 1, 0, or −1. For a given focus, other activation is the sum of yesterday's activation of compatible foci minus the sum of yesterday's activation of incompatible foci. To reflect the impact of neighboring foci, the other activation term O_{f,t-1} is incorporated into equation (1) to yield:

A_{f,t-0}=E_{f,t-0}+c_{f}A_{f,t-1}−n_{f}O_{f,t-1}+ε (3)

where:

n_{f}=neighbor influence, the proportion of other activation that impacts the focus

Logical limits are imposed on the total effects of neighbor influence in that the requirement that activation cannot be reduced below zero as the result of application of equation (3), and the requirement that influence from incompatible foci cannot increase carryover beyond the level associated with no dissipation. Incompatible neighbors can interfere with a focus” dissipation or even prevent it from dissipating any activity, but they cannot increase its level of activation. Activation of a focus can only be caused by the occurrence of triggering events associated with a focus.

The computational organization model of interaction between the foci in the grocery store is thus based on equation (3) and the logical constraints just described. Running the model with various sets of triggering events provides a picture of how the activation levels of individual foci change under complex conditions of interaction with other foci. It also shows how different values of the deactivation rate and neighbor influence parameters affect the individual foci and total activation in the system.

The model allows the user to set the dissipation rate parameter for each focus, set the neighbor influence parameter for each focus, and specify a symmetric matrix of compatibility parameters. The model also allows the user to set a constraint parameter for each focus to allow for that characteristic of foci. However, to simplify the present discussion, the constraints are assumed to be equal for all foci, and therefore does not affect calculations of other activation. The triggering event magnitudes are input for each focus for each day; the first set of these functions being the starting values for the model. On each time step (day) the model calculates, for each focus, the carryover from the previous day and the other activation for related foci. The model then weights and adds these according to equation (3), checking to insure that the activation level is within the limits described above. Next, the model dithers the sum by a small, randomly generated number to account for the error component of equation (3). Finally, the model updates and displays the activation levels for the foci and sums across foci to yield a measure of total activation in the system, and proceeds to the next time step.

An appropriate array of parameter settings and inputs must be determined for the model. The scale for the magnitude of triggering events (i.e., the inputs to the model) is arbitrary. The scale is common across triggering events for each focus and across multiple simulations. This allows comparison of the activation levels of foci to one another, and assessments of total system activation in runs using a similar input scale.

Next, the deactivation rate and neighbor influence parameters are set. It is assumed that the parameters for deactivation rate and neighbor influence, respectively, are equal across all foci and constant across time. However, it is possible for the parameters to change across time.

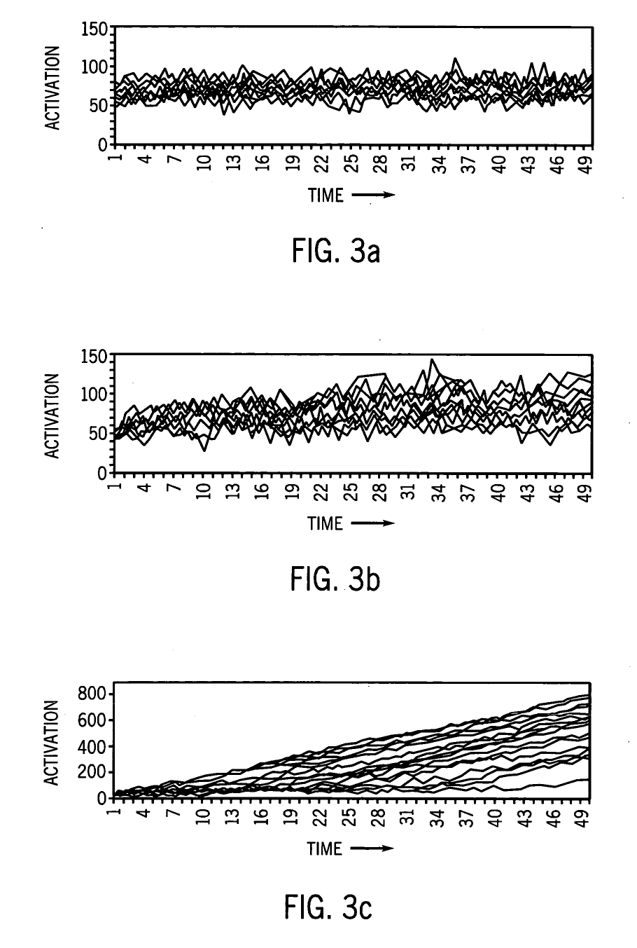

Consider a set of inputs to the model. The triggering events are set with a magnitude from 0 to 10 for each combination of several carryover rates (0.4, 0.6, 0.8) and neighbor influence values (0.1, 0.3, 0.5, 0.7, 0.9). For a given pair of parameter values (e.g., carryover =0.4 and neighbor influence =0.1), triggers for each of the eleven network foci are generated for 50 days, and total activation for each day is recorded. The process is repeated several times for each pair of parameter values, and the resulting series are plotted on common graphs for comparison purposes as shown in FIGS. 3-5.

FIG. 3a shows the graph for each network foci with carryover =0.4 and neighbor influence =0.1. There is an initial accumulation of activation represented by an upward bend in the band defined by the different trials. However, after day 7 or so, total activation in all cases varies about a steady mean activation level of 73.4. Even in cases where the total activation increases well above the mean, the system is capable of bringing the total level of activation back down. Thus, under low levels of carryover and neighbor activation, the system maintains an equilibrium state.

FIG. 3b shows the effect of increasing neighbor influence to 0.3. As with the previous case, there is an initial upward bend in the band, which stabilizes after a few days. However two differences from FIG. 3a are apparent. First, the series vary about a higher mean level of activation, 80.2. Second, the band is wider and less coherent than in the case of lower neighbor influence, which is born-out statistically in the average series variance for the two sets of trials, 125.2 versus 207.5 for neighbor influence values of 0.1 and 0.3, respectively. Thus, a slight increase in neighbor influence results in higher mean activation and greater variation in response to triggering events, but total activation still remains in equilibrium.

Increasing neighbor activation to 0.5 yields a qualitatively different pattern, as shown in FIG. 3c. After rising to an initial level of activation between 70 and 80 in the first 5 days, the system waits between 0 and 20 days before total activation assumes a steady upward course. The shift from steady to upward-trending total activation is a manifestation of disequilibrium in the model. The activation system has gone into an accumulation mode. As neighbor influence increases, activation of incompatible foci has greater potential to decrease dissipation (increase carryover) for a given focus, and at a certain point will prevent a focus from dissipating any activation at all. The mean activation can only increase as the focus accumulates new triggers. Accumulation mode happens when two or more mutually incompatible foci reach the point of no dissipation, and mutually prevent one another from dissipating activation. It takes time for sufficient activation to accumulate to reach this point, which explains the variable waiting time in the different trials shown in FIG. 3c. The accumulation mode is typical of other combinations of carryover and neighbor influence. In general, there is a point at which increasing neighbor influence pushes the system into an accumulation mode. The higher the carryover, the lower the level of neighbor influence needed to reach this point. It is also true that additional neighbor influence does not seem to have much effect on the series beyond the critical point. That is, the graph in FIG. 3c does not look too different from the graphs for neighbor influence levels of 0.7 or 0.9.

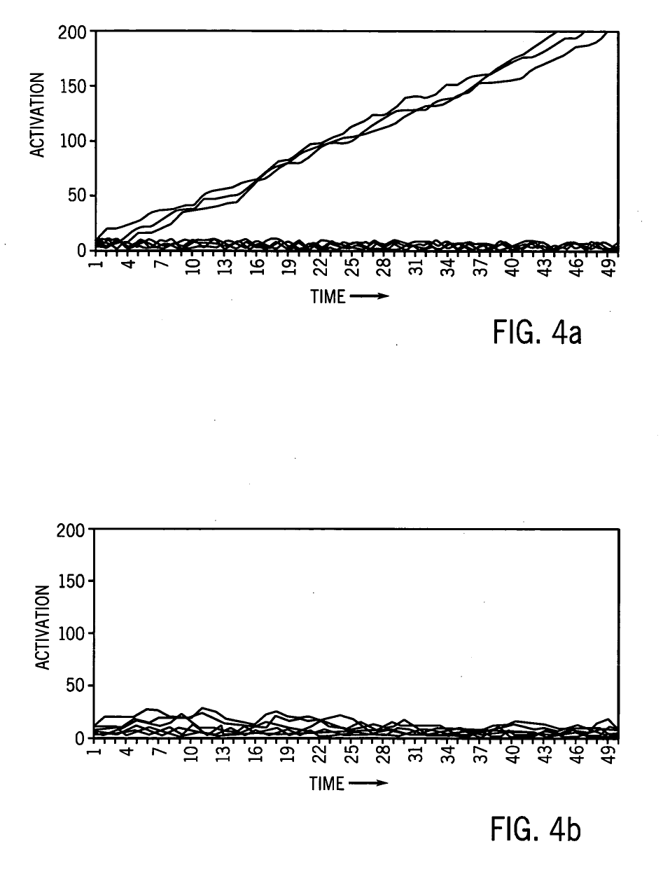

The individual foci have their own activation levels that bear examination. FIG. 4a shows the activation levels for the eleven network foci under one set of inputs with parameter values of carryover =0.4 and neighbor influence =0.5. FIG. 4a shows that three foci—managing people, vendors & DSD, and regulation—are responsible for the steadily increasing activation in the system. The rest of the foci maintain their activation at fairly constant levels.

Reducing the neighbor influence to 0.3 (same triggers) produces the graph in FIG. 4b. Although the parameters approach, they do not cross. The critical threshold leads to constant accumulation of activation. Three of the foci vary widely compared to the remaining eight. The variances of the series in question quantify the difference: managing people =27.7, vendors & DSD =21.6, and regulation =44.1, compared to an average of 11.3 for the eight other foci. Triggering events are necessary in initiating the interactions that lead to constant accumulation of activation. However, managing people, vendors & DSD, and regulation are all mutually incompatible. Incompatible relations make foci sensitive to inputs, and make them more variable as the threshold is approached and they become more prone to going into accumulation mode.

Simulations with random data provide important insights about how the activation model responds to triggering events in general. However, as we noted above, triggering events are not random. They are important determinants of the activation levels of foci over time. Based on the observations, a structured set of triggering events representing a conjectural two weeks in the life of the store is shown in Table 1.

TABLE 1
Magnitude Categories for Triggering Events

| Magnitude | Explanation | Example |
|---|---|---|
| 1 - low | These types of | Sort mail, check the |
| | activities are | sales readings, help |
| | always occurring but | on the cash register, |
| | not within a | answer the phones, |
| | certain time frame | straighten and face |
| | or not in a way that | the shelves |
| | precludes other | |
| | activities from | |
| | being taken care of | |
| 5 - Medium | Regular activities | Reports, scheduling, |
| | but they need to be | video/lotto counter |
| | accomplished on a | |
| | set day due to their | |
| | impact on other | |
| | store activities | |
| 10 - High | Activities preclude | Product recalls, |
| | attention being paid | health inspections, |
| | toward other | shop lifting, dealing |
| | activities | with plumbers or |
| | | electricians |
| 20 - Very High | Activities involve | Holiday sales |
| | almost all aspects | |
| | of the store and | |
| | require a period of | |
| | time to prepare for | |

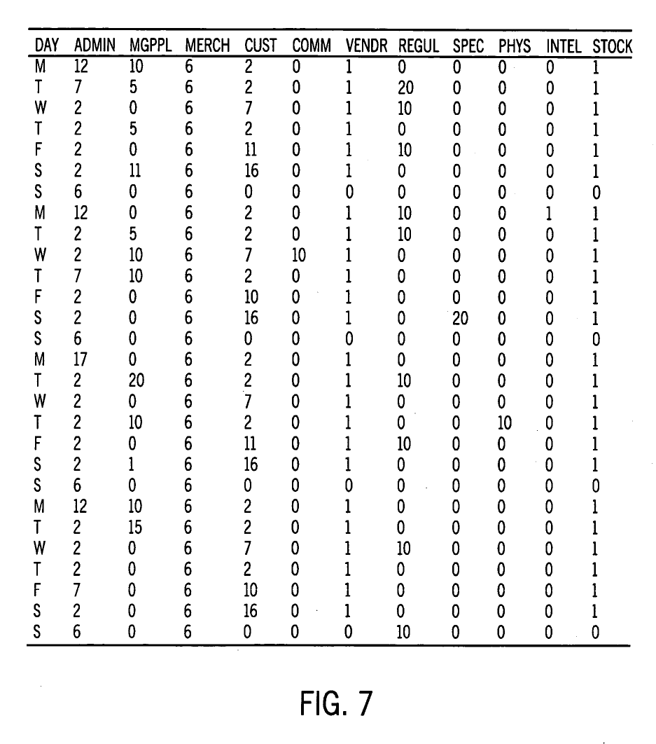

Table 1 is formed from interviews and observation with managers and employees of the grocery store. The session provided information to (1) identify activities or activity clusters, (2) estimate the magnitude of the associated triggering event using the categories shown in Table 1, and (3) develop a sense of the timing of the activities. The information is used to estimate the occurrence, timing, and magnitude of triggering events in the typical two weeks in the life of the store. In any cases where more than one triggering event occurred for a given focus for a given day, the magnitudes for the events are summed to provide a single input value. The resulting values are shown in FIG. 7.

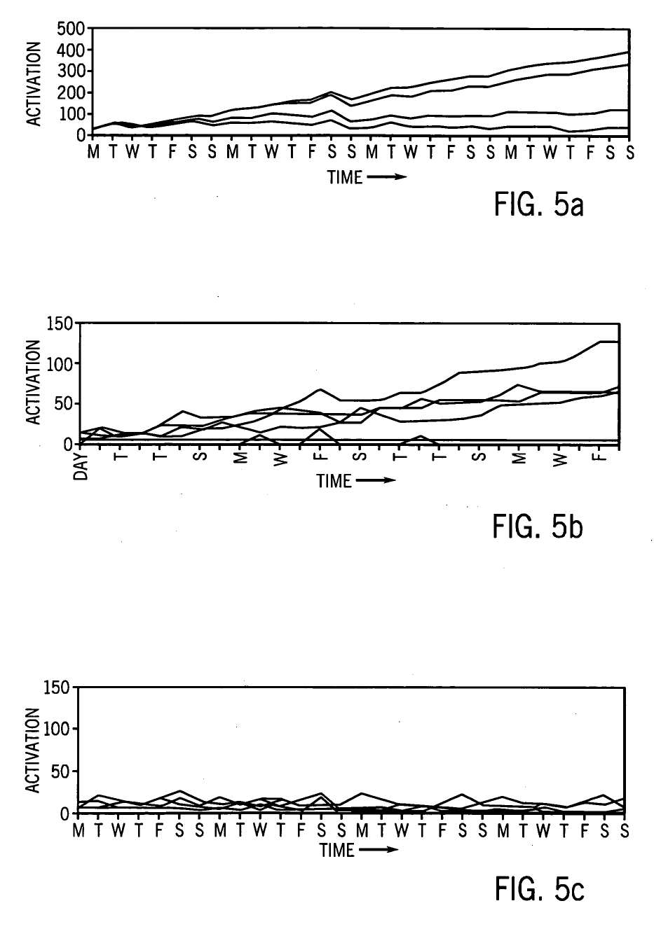

Following a similar procedure described above, the structured triggers are processed through the model using several combinations of carryover rates and neighbor influence values, then plotted the total activation and individual focus activation series on common graphs for analysis. FIG. 5a shows total activation for carryover =0.5 at four different levels of neighbor influence. At low levels of carryover and neighbor influence the system remains balanced. But as neighbor influence increases the system at some point becomes locked in an accumulation pattern. The general pattern across different levels of carryover is also consistent with that in the random data: the higher the carryover, the less neighbor influence is required to induce accumulation mode.

FIG. 5b shows the activation series for the individual foci under carryover =0.5 and neighbor influence =0.6. Most of the foci remain in balance, while a few others become locked in an accumulation mode. The customer service, managing people, regulation, and administration foci are the ones that lock in an accumulation mode. It is also noteworthy that across the different values of carryover and neighbor influence, customer service accumulates activation the fastest once the system hits the accumulation mode. Customer service has, in general, the highest magnitude of triggering events, so it naturally accumulates activation the fastest once it loses its ability to dissipate.

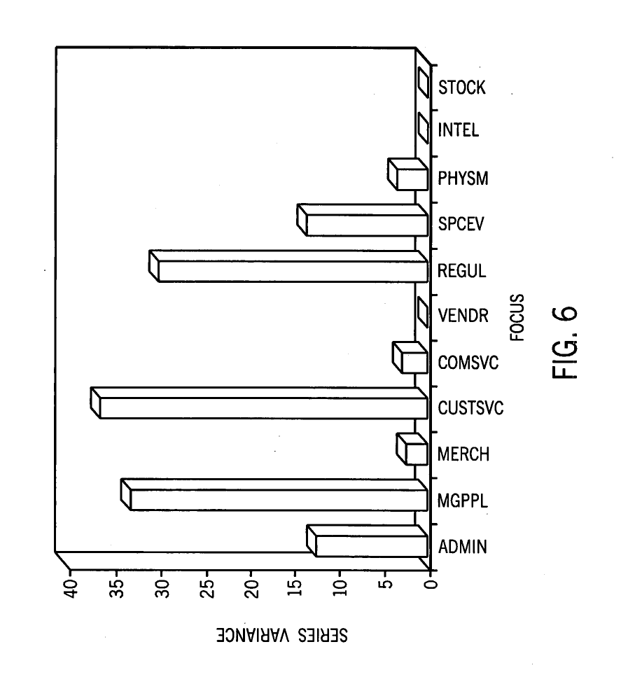

FIG. 5c shows the activation series for the eleven network foci for parameters of carryover =0.4 and neighbor influence =0.3. FIG. 6 shows the series variances for the network foci. The foci that go into accumulation mode under increased neighbor influence (customer service, managing people, and regulation) show higher variances than the others. The anomaly, however, is the administration focus, which goes into accumulation mode along with the three other foci. It has a slightly lower series variance than special events, which never goes into accumulation mode.

The model demonstrates the value of representing foci as a structured network of interdependency relationships of compatibility and incompatibility. Casting foci as an influence network systematizes them, and opens the possibility for complex interactions that cannot be described by study of any one or two foci in isolation. The network concept also allows application of computational models to trace the behavior of the foci over time.

The model offers several important insights into the interaction of activity foci at the grocery store. The system has a stable or balanced state. When the values for carryover and/or neighbor influence are small, the system of foci is able to dissipate activation in a consistent and predictable manner. The total level of activation in the system seems to increase with the carryover rate, but the random trials show that total activation tends to stay under control, varying about a constant mean level. As long as the foci are dissipating most of their activation in a time period, and are not too strongly influenced by incompatible neighbors, the system functions effectively despite its structural contradictions.

There is a point at which sets of negatively related foci become locked in a pattern of accumulating activation. The point at which this occurs depends on the values of the carryover and neighbor activation parameters: the higher the carryover, the lower the value of neighbor influence at which the accumulation mode occurs. Once in this mode, the foci continue to accumulate triggering events, but mutually interfere with each other's ability to dissipate the resulting activation.

Accumulation mode must be viewed as a breakdown in the activity system. If the logic behind the model is valid, grocery stores could not possibly operate in this mode for any significant length of time. The human agents who do the activity that dissipates the activation could not infinitely expand their ability to do the activities. There must be some mechanism that corrects the system when it gets close to or over the threshold for the accumulation mode.

The system constitutes dissipative structure, that is to say, the system functions in an orderly manner until critical environmental perturbations (triggering events) push the system into a far from equilibrium state (accumulation mode). At this bifurcation point, the system spontaneously reorganizes in a way that exports entropy back to the environment, reestablishing equilibrium. This is an appealing explanation because many people have experienced times when matters at work or some other organization have gotten out of hand. Very often, things will get out of hand as a result of some event that pushes the organization over the limit of its ability to deal with activities, and this is reminiscent of the threshold seen in the activation model.

A feature of dissipative structures is that they are nonlinear at the bifurcation points, meaning that there is more than one way of reorganizing to cope with the disequilibrium. There are several ways that the deactivation system in the grocery stores could reorder itself. First, the system could circumvent accumulation by reconfiguring its parameters. The simulations show that when the system is in accumulation mode, changing the carryover rate has no effect unless it is changed to zero. Even then activation is only dissipated slowly because highly activated, incompatible neighbors are preventing dissipation. Logically then, the best way to break out of accumulation mode, while maintaining the existing network of interfocus influence, would be to modify the neighbor influence parameters, circumventing the influence of highly activated, incompatible neighbors. This could be accomplished by assigning personnel to one or the other of a pair of incompatible foci, reducing the competing demands placed on employees who are activated by both.

Second, the system might reorganize the system of foci itself, creating a new structure for the activity system. Radical reorganizations would be possible, as in the case of a store going out of business, but less dramatic changes are also possible. For instance, the store could create a new focus that is compatible with the problem foci, effectively counterbalancing the activation that is accumulating in them. The stores could even develop a new way of conceptualizing what they are doing, adopting a new business model. In this way they could literally transform the entire set of foci and the relations between them.

Third, since it is particular triggering events that push the system into accumulation mode, the stores might also reorganize the coding conventions responsible for enacting them. One way to do this is to increase the threshold for enacting events associated with incompatible foci. Dropping inputs is a common way for humans to cope with overload, and perhaps the stores cope with overloaded foci in an analogous way. The store managers may delay administrative work until the demands from corporate headquarters forced them into action. Thus it may be that the system reorganizes not the activity system, but the enactment modality in an effort to counteract disequilibrium.

The computational organizational model provides a methodology for the grocery store to understand the activity levels associated with its day-to-day functions. Once interdependencies between foci identified and activity levels resulting from triggering events quantified, then the grocery store can manage the foci to optimize the operations of the store. In general, the management involves changing foci or interdependencies between foci to increase dissipation for activations. When the time and effort required to get things done decreases, the operation of the store becomes more efficient. The model of the complex system increases understanding of its complex interrelationships and identifies where and how the system can be optimized.

Complexity models, including dissipation structures are both intriguing and fashionable ways to think about organizational processes. However, there is a simpler explanation of how the store activity system might counteract accumulation. The stores may employ a feedback control system to prevent themselves from ever entering accumulation mode. If, the system can change its neighbor influence parameters, then it could just as well do this in advance of the point where it gets into trouble, providing there is information that could trigger preventative measures. When the parameter settings for the model approach but do not exceed the threshold that induces accumulation, the variance of the activation series for the problem foci increases drastically. It is plausible that employees recognize abnormal fluctuation in activities associated with a focus and/or in communication between people associated with those activities—periods of feast and famine. If such a pattern of fluctuation (and a regulatory mechanism based on it) are shown to exist, it would mean that meso-level structural contradictions act as variance amplifiers in the activity system and therefore that the activity system provides the means for its own regulation.

There is no reason that a dissipative structure and a feedback control system for neighbor influence should be considered mutually exclusive. It may be that the organization uses activation variance information to direct slack resources to problem foci, but that the system sometimes overwhelms its capacity to cope in this way, inducing accumulation mode and subsequent reorganization of the activity system. Thus a dissipation structure with a feedback control system in its equilibrium state is logically possible, and may suggest a two-stage defense against accumulation. The punctuated equilibrium implied by the dissipation structure should be quite noticeable as a critical incident, and therefore amenable to empirical study. A history of the punctuations and the associated reorganizing may be observed along the three lines suggested above. There should be evidence that store personnel monitor the variance of activities and/or communication in the store, and use this information to allocate slack resources to problem areas.

Consider another example of the computational organizational model as applied to terrorist networks. The predominant idea for using network concepts to fight terrorists centers on disabling key parts of their communication networks. Activity focus networks (AFNs) represent the complex activity system of an organization. An activity focus is a conceptual or physical entity around which joint activity is organized. Any organization has a number of these, which are in some cases compatible and in some cases incompatible. The set of foci and their relations of compatibility and incompatibility define the AFN. It shows that certain activity foci, and in particular one combination, have high potential as pressure points for the activity system. The AFN approach complements the counter-network approach by reducing the downside risk of incomplete information about the communication network, and enhancing the effectiveness of counter-network approaches over time.

There is growing recognition that terrorist organizations are structured like network organizations. Terrorists can compose their organizations of small, geographically dispersed cells coordinated with the larger organization by rarely-used communication channels. If terrorists′ successes result from a well-structured network, then an obvious strategic principle for fighting terrorist organizations is that harming their network should impact their effectiveness. By studying the structure of an AFN it is possible to identify ways to stress an organization by impeding its ability to efficiently discharge activity.

Activity foci can be used to represent the way terrorists conceptualize their organizational world. At the top is usually the leader, and below may be a consultative council consisting of military, religious-legal, finance, media, and security advisers, which is responsible for directing operations of the larger organization. The terrorist organization typically has fairly clear strategic goals, and may assign particular people to specialized roles to pursue its coordination efforts. Vertical hierarchy, functional specialization, and strategic behavior all indicate a classically organized top end for which planning is a critical focus of activity.

Other foci are suggested by specializations in the coordinating council. The military position indicates that a major focus of activity in the organization is carrying out its operations, which consist of attacks on perceived enemies. Lower in the organization, certain cells are thought to be dedicated to carrying out these operations, while other cells provide them with resources such as weapons, materials, equipment, false identification, information, which they need to be successful. Logistics activities are a separate focus.

The religious-legal position in the consultative council is emblematic of the focus on ideological control. The unconventional nature of religious and political ideology means that significant organizational resources must be expended to keep organization members on the right path and quell any developing doubts. Thus, the public rhetoric is peppered with religious arguments and scripture quotations.

Of course the organization also must be concerned about the failure of ideological control, and this shows in its obsessive focus on security. In internal documents it may fret about cunning enemies bent on infiltrating the organization. Members of the organization are required to swear oaths of allegiance. Security is also an obvious priority in terms of maintaining the stealth of operational and support cells, which explains its position on the consultative council.

The consultative council also includes a position related to finance. An institutional funding focus deals with raising money from state actors or other high-profile donors who cannot to be associated with actual terrorist operations that result in death and destruction of property. These sources fund projects that are more legitimate, like building training camps. Operational funding, on the other hand, is probably more clandestine and is used to actually finance attacks and logistics preparation for attacks.

Two more foci have to do with getting members into the organization. Most terrorist organizations need recruits for which it relies on good community relations within Muslim communities and at Mosques worldwide, as well as supporting communities in countries where leadership operates, financing religious schools, and so on. Other foci can be discerned from certain public rhetoric. The organization may have a formal concern with PR/External Communication. The leadership may pursue a media strategy through videotaped messages, interviews with reporters, messages sent through Muslim satellite TV networks, and so on.

The activity foci for the terrorist activity system include: planning, operations, logistics, ideological control, security/stealth, institutional funding, operations funding, recruiting, community relations, strategic alliances, and public relations/external communications. Planning involves developing strategy that directs the operations of the organization. Operations involve carrying out attacks against the enemy. Logistics involve providing information, material, and assistance necessary to conduct operations. Ideological control involves maintaining members′ belief in the ideology underpinning the organization. Security/stealth involves keeping the organization secret and acting against internal threats.

Institutional funding involves raising money used for activities that do not directly result in death and/or destruction of property. Operations funding involves raising money used for activities that result in death and/or destruction of property. Recruiting involves finding and vetting potential new members of the organization. Community relations involve maintaining good relationships with the communities from whom the organization draws support. Strategic alliances involve forming and maintaining relationships with other terrorist organizations. Public relations/external communications involve communicating with the outside world through various media.

Having defined the foci, it is necessary to specify the relations of compatibility and incompatibility between them. The focus with the most relations (highest degree) in the AFN is security. Because it is a clandestine organization, security is implicated in just about everything the terrorist organization does. While security is likely incompatible with some foci, it does have compatible relations with planning because a secure environment facilitates more extensive planning, and with ideological control because good security helps prevent enemies from penetrating the organization and spreading dangerous ideas through its communication network. Good ideological control causes commitment to the organization among members, who then see its security as being in their own interest.

Ideological control has compatible relations with operations and funding. Ideological control also facilitates external fund raising. It is widely believed that an international network of financiers and charity front organizations support their goal of expelling crusaders from the Arabian Peninsula and establishing a region-wide Islamic caliphate by providing support to terrorist organizations. Ideological control does have incompatible foci. Strategic alliances complicate ideological control because they mean the organization must interact with partners whose ideological interests may differ. Recruiting is also incompatible with ideological control because recruiting activities generate fresh uncontrolled members, and thus the need to generate activity and communication that will be needed control them.

Recruiting is incompatible with operations, as terrorist operations tend to consume members who must be replaced by fresh recruits. Recruiting is compatible with institutional funding and community relations, because it is recruiting activities that bring the organization most directly into contact with the community, as well as sources of funds for respectable operations. Good community relations is compatible with planning, logistics, and strategic alliances because the organization operates as a network that exists mostly virtually, spread over many communities worldwide. It is the support of these communities and alliances with other groups within them that allows the terrorists to plan and coordinate their attacks.

Strategic alliances are incompatible with planning because the wishes of others in the alliance must be taken into account. On the other hand, alliances probably play an important role in legitimating the organization in its external communications. The PR/Media focus is compatible with operations, as attacks focus attention on the organization and its message and seem correlated with increasingly frequent releases to the press. These excite sympathetic people and groups, facilitating efforts to secure ongoing institutional funding for the organization.

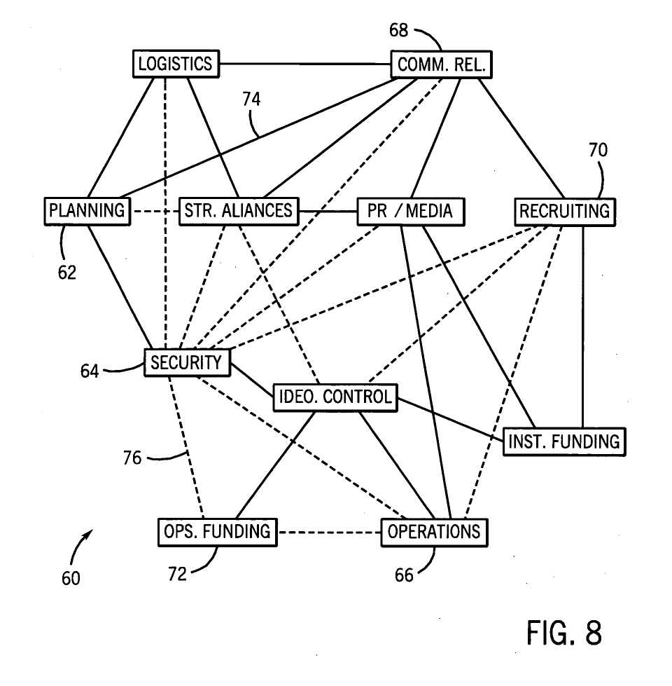

The complete activity focus network 60 as described above is shown in FIG. 8. The network foci are shown for example as blocks 62, 64, and 66, representing planning, security, and operations, respectively. Each foci within complex network 60 has connections or links to other foci. Planning block 62 is connected to security block 64 and to community relations block 68. Likewise, security block 64 is connected to operations block 66 and to recruiting block 70. The links can be color coded or shaded to identify the sign and magnitude of the interdependency. Not all foci are directly connected to other foci. Planning block 62 is not directly connected to operations block 66. Community relations block 68 is not directly connected to operations funding block 72.

The links or connections represent relationships and interdependencies between the network foci. The interdependencies can be positive or negative, compatible or incompatible. The magnitude of the interdependencies can be expressed in absolute form such as +1 or −1, or as a real number. Link 74 between planning block 62 and community relations block 68 may be +1 to indicate a compatible relationship. Link 76 between security block 64 and operations funding block 72 may be −1 to indicate an incompatible relationship. The lack of connection indicates independence, unrelated, or substantially zero interdependency between the respective foci.

The structure illustrates how someone working with comprehensive information might go about building such a model. To the extent that information appearing in the public record is accurate (and accurately reflected in the model) it could identify actual weaknesses in the terrorist activity system.

The AFN shown in FIG. 8 can be simulated as a discrete time cellular automaton. The foci become cells in the automaton, and their neighbor cells are defined by the links in the AFN. Each cell assumes a series of states or values based on inputs to the system and interactions with neighbor cells, both of which happen in discrete time steps. Inputs to the simulation are triggering events that can be external events that represent inputs or planned events triggered by dates on a calendar. The state assumed by the foci is activation, an imperative for doing the activities organized by a focus. The core process of the model is that triggering events cause activation in foci, then the organization dissipates this activation by doing activities associated with the foci.

Added to this basic process are constraints imposed by the context and the AFN. First, activity is a limited resource, especially in the short run. For any discrete time interval, there is a constraint on how much activity the organization can generate to dissipate activation in its foci. In cases where there is too little activity to dissipate the activation, it does not merely go away. If it is not dissipated at a given time, activation carries over to the next time.

Second is the effect of neighboring foci. For some focus X there is also a potential set of compatible and incompatible neighbors. Compatible neighboring foci essentially improve the ability of the organization to dissipate activation in X by facilitating double-dipping with people and/or activities. Conversely, incompatible neighboring foci impede its ability to dissipate activation in X, because they represent competing demands for the same activity resources.

The process and its constraints can be realized in equation (4):

A_{f,t-0}=E_{f,t-0}+c_{f}A_{f,t-1}−d_{f}[Σ_{i≠f}(N_{i,f}·A_{i,t-1})]+ε (4)

where:

f is some focus

t is some discrete time period

A is an activation level for a focus

E is an activation input due to triggering events

N is a value from a square, symmetric adjacency matrix representing the AFN, with possible values {-1, 0, 1}.

The activation of some focus f in the present time period is a sum of activation by its triggering events at time present, plus some proportion of activation carried over from previous time periods, plus a weighted sum of the last time period's activation for compatible and incompatible neighboring foci.

Two parameters and one restriction control the behavior of the model. As discussed above, the organization can only do so much in a given time. Parameter c accounts for carryover as a weight on a first-order autoregressive component. Conceptually, it represents the portion of the activation in a focus that the organization cannot dissipate in a discrete time unit. A related restriction is that activation may not fall below zero for any focus, meaning that it is not possible for the organization to bank activities against future activation.

The dependence parameter d allows moderation of the effects of neighbors. It is not reasonable to assume that compatible or incompatible neighbors have an absolute inhibiting or facilitative effect on a given focus. Organizations can insulate activities to some extent, allocate slack resources, or take other steps to keep activity foci independent. So the dependence parameter d allows for variation of the effects of neighbors, and thus for testing the effects of tighter or looser coupling on the behavior of the simulation.

Major operations tend to work on an approximate 18 month cycle. The strategy is to create input series for the operations focus corresponding to this sort of cycle, then base the other inputs on a plausible timing scenario. The values for the input series are based on an abstract scale of zero to 100 activation units. In general all the input series started as a random numbers, and some of these are modified to create peaks in activity.

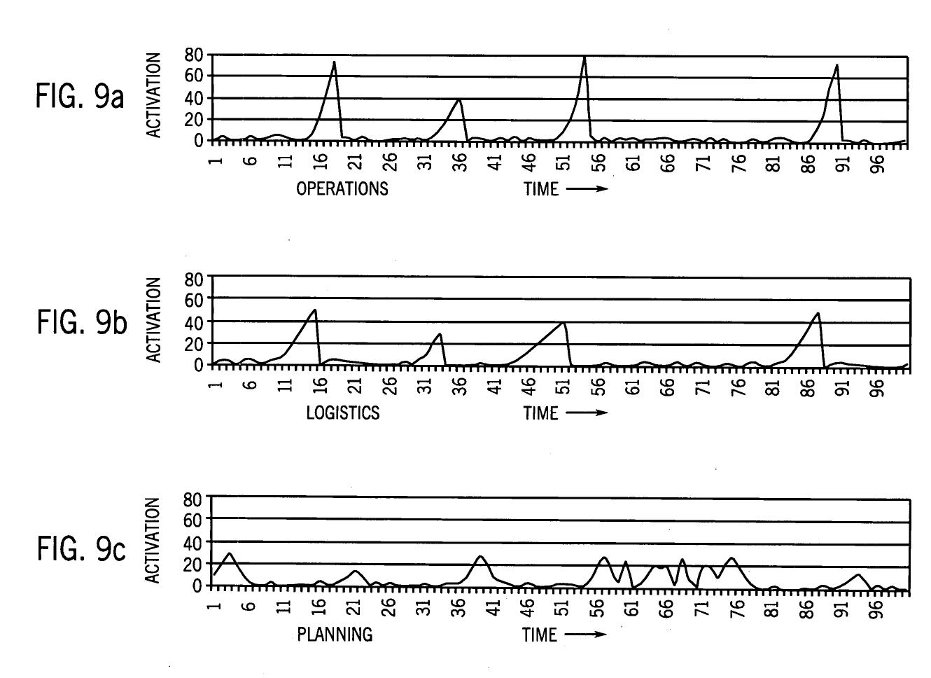

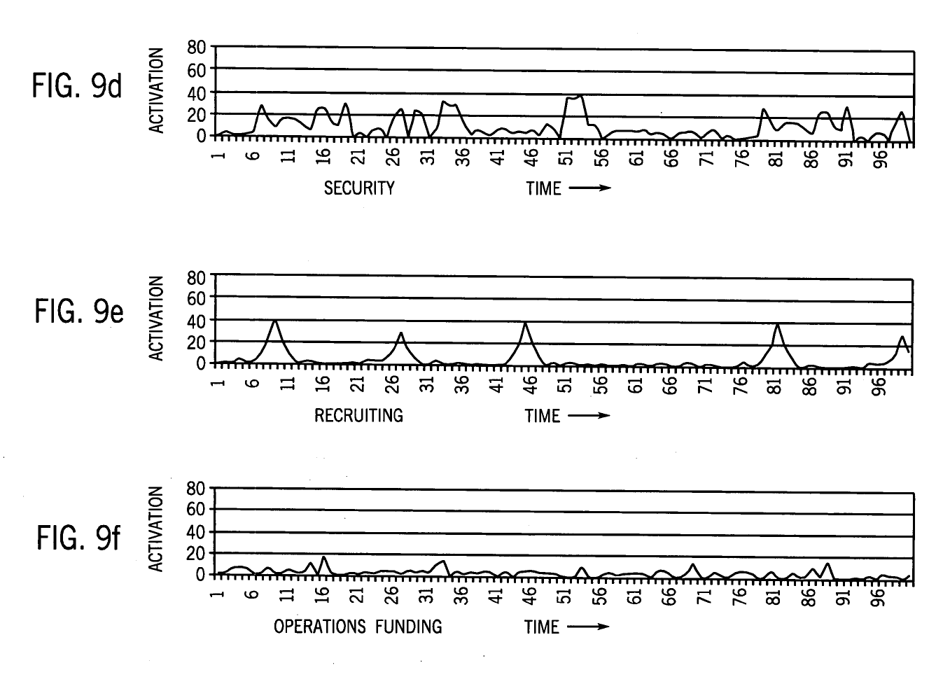

FIGS. 9a-9f show the input series for six of the network foci. The others are assumed not to be closely linked to operational timing, and therefore are set to have consistent random variation around a mean of 10 activation units. There is a peak in operations every 18-24 months. The third peak represents something major, and the fourth is delayed owing to a presumed need to recover from retaliation for the major attack. Operations funding spikes up slightly just prior to each attack, but not too far because the terrorist organization attacks are thought to be relatively low cost operations. There is a large spike in logistics prior to each attack, and a spike in recruiting before logistics. Security events increase before and after all the operations peaks. Planning occurs at the head of each cycle, with an extra dose after the major attack. The simulation is run by stepping through each time period and calculating equation (4) for each focus, yielding an activation series for each focus.

As shown in the grocery store model indicated that the system would achieve stable dissipation of activation at low settings of the parameters. However, with higher settings of the parameters, at some point the system becomes too sluggish and tightly coupled, and it shifts to a state where there is accumulation of total activation in the system.

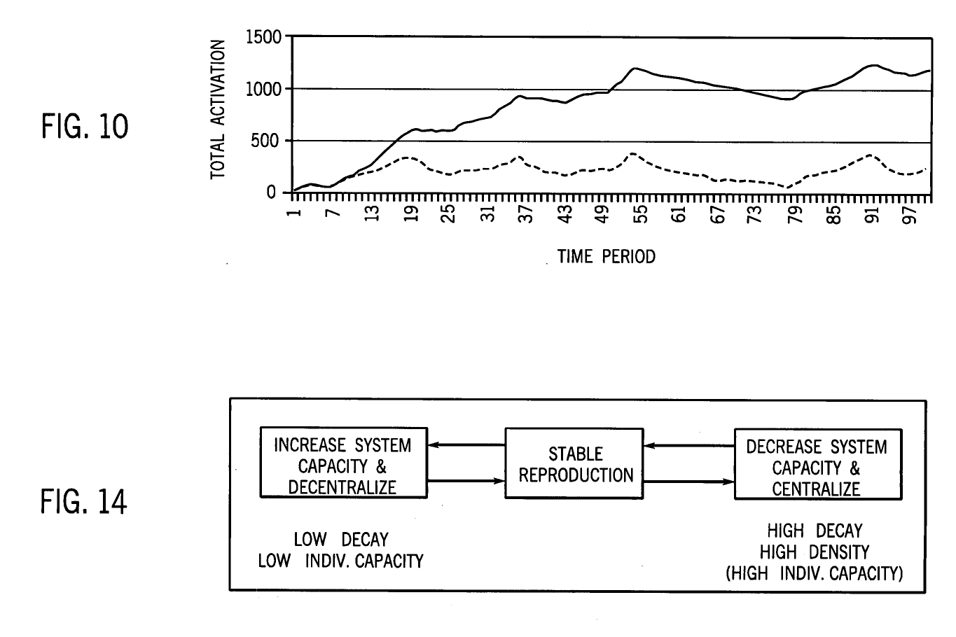

The dotted line on FIG. 10 shows the model in a steady state at carryover =0.3 and dependence =0.2. Here though activation does get quite high in some of the foci, it generally tracks the shape of the input activation curves shown in FIGS. 9a-9f, and the total activation of the system does not trend upward. Only a small difference in one parameter changes this picture. The solid line on FIG. 10 shows the graph of total activation for c=0.3 and d=0.25, respectively. A five percent change in the dependence parameter tips the system into a mode where total activation in the system steadily accumulates. The system is no longer taking care of business by generating enough activity to meet demand.

This accumulation mode must be considered a dysfunctional state that the organization seeks to avoid. Normal operations of an effective organization must exist somewhere under this threshold, probably as near to it as safely possible. Reducing carryover significantly would be costly, requiring lots of excess capacity at down times. Likewise, it is difficult to perfectly insulate different areas of activity in an organization from one another. So, taking c=0.3 and d=0.2 are reasonable estimates of the normal operating state.

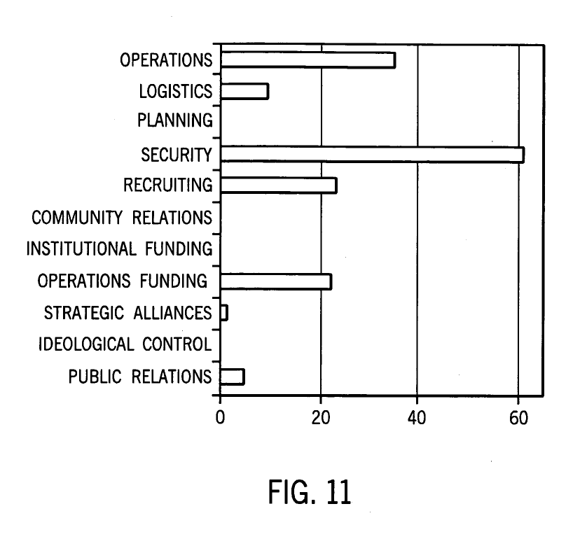

With the baseline, it is possible to use sensitivity analysis to determine which of the foci are potentially most troublesome for the organization. The carryover is increased for each focus to c=0.5, leaving all other parameters the same. The model computes the change in total activation relative to c=0.3 for all foci. The results are shown graphically in FIG. 11. Some foci, like ideological control and institutional funding, change negligibly in response to a change in their own carryover, indicating that they are protected by their positions in the activity system. For most other foci increasing carryover has a system-wide effect. Security has the greatest sensitivity, increasing activation in the total system by 61 units on the average, followed by operations (35 units) and recruiting (23 units).

As a complex system, it may be possible to achieve bonus effects by raising carryover in several foci simultaneously, as opposed to doing so for single foci individually. As stated above, individual increases in carryover of the top three foci increased total system activation between 22 and 60 units. The sum of these values is 117, the amount of activation increase that might be expected from serial efforts to increase carryover for these foci. On another run of the simulation, carryover for security, operations, and recruiting is increased simultaneously. The effect is an increase in average total activation of 167 units, a 42% bonus in activation created in the organization. Furthermore, the combination of the carryover increases induces accumulation mode in the activity system, whereas the individual increases do not.

According to the model, increasing the carryover for security would be the best single means of increasing total activation in the organization. This might involve taking steps to slow the security process or otherwise make it more difficult, impairing the ability of people who are responsible for security activities to dissipate activation. Increasing the number of inputs to the security focus would have a similar effect. However, a combination of simultaneous actions against the security, operations, and recruiting foci appears much more effective. It causes 43% more activation than the sum of increases for the individual foci, and more importantly it causes the dysfunctional and therefore stressful accumulation mode.

Small changes in nodes or links can drastically alter the structural features in a network. The combination of a clandestine organization and less-than-perfect intelligence means nodes that look structurally important may not really be so important, and vice versa. AFN approaches like the one demonstrated in the model can help mitigate this problem by reducing the downside risk of incomplete knowledge of the communication network, and by increasing the chances of getting more complete information about it.

First, an AFN approach can reduce the downside risk of counter-network approaches. Recall that the foci used in AFNs do not describe single actions, but a range of activities undertaken by multiple factors. Actually applying the results from a simulation like AQAS would mean making it difficult or impossible for particular people to carry out particular activities, overloading them with inputs, and so on. Yet because it describes the macro-activities of groups, the AFN gives little guidance as to which of these people or activities would make the best objectives. Counter-network approaches, in contrast, are all about identifying the best objectives. So in this sense the two approaches are synergistic: the AFN approach identifies a general range of people and activities to be operated against, and the counter-network approach gives guidance as to who and what should be the specific focus of operations.

The benefit is that the combination mitigates the downside risk of incorrect counter-network assessments due to bad or incomplete intelligence. Impairing someone's ability to complete activities will have the desired effect from an AFN perspective even if they are not the most important person in the communication network. In other words, if you are wrong about the communication network you still accomplish the goal of disturbing the activity network, and so much the better if you are right about the communication network.

Second, application of AFN strategies can enhance the effectiveness of counter-network approaches over time. This is because communication and joint activity always go together. Thus if the total activation in an AFN increases, the communication among organization members will increase also.

This form of synergy between the counter-network and AFN approaches is particularly valuable when dealing with a clandestine organization. Their objective is to keep members and their ties unknown, yet stimulating or impeding their activity system tends to surface their communication network. So there is positive feedback between the AFN and counter-network approaches. Pressure on the activity system causes members to communicate more. Increased communication makes it easier to gather and verify information about the network, which improves the effectiveness of counter-network approaches. More effective counter-network efforts make the communication network less able to effectively coordinate efforts of the members. Less coordination effectiveness makes it easier to put additional pressure on the activity system, completing the loop.

Thus, the computational organizational model also provides a methodology to disrupt the activities of terrorist organizations. Again, by understanding interdependencies between foci and activity levels resulting from triggering events, anti-terrorist organizations can manipulate the foci of the terrorist complex system to cause problems for its functions. In general, the anti-terrorist groups change the foci or interdependencies between foci to decrease dissipation for activations. When the time and effort required to get things done increases, the operation of the terrorist organization becomes less efficient. The model of the complex system increases understanding of its complex interrelationships and identifies where and how the system can be manipulated for the desired result, in this case to be disruptive to the terrorist's complex network.

Activity focus networks (AFNs) are a good way of augmenting counter-network strategies. By understanding how an organization focuses its activities and the relationships between these foci, one can define a network that represents the organization's activity system. The model tests one such speculative AFN for the terrorist organization, and shows that pressuring some foci impacts the system much more than others. However it is most vulnerable to simultaneous pressure on three key foci. Using results like this in combination with counter-network approaches can lower the risk of bad intelligence about the communication network and is likely to make counter-network approaches more effective over time.

The above model revealed two modes of the activity system in the store, determined by parameter settings. One is homeostatic, wherein the system maintains net dissipation of all the activation induced by triggering events. In the other state, accumulation, incompatible foci become grid-locked and lose their ability to dissipate activation. Because gridlock presumably could not be the normal state of an organization, the parameter settings for a stable state are used to generate the activation inputs for the present simulation. This amounts to an assumption embedded in the parameters of the other simulation, whose data are feeding the present one: the activity system maintains homeostatic balance, meaning that the activity system is taking care of business by dissipating all of the activation that comes from the triggering events. Logically, communication phenomena in the reticulation modality are necessary for carrying out the activities. Thus it must be the case that the communication system keeps up with the activation too, generating sufficient communication to deal with whatever activation level might come along.

A second assumption is that individuals are limited in their abilities to generate and attend to communication. This is a well-supported finding that, when combined with the first assumption, has important implications for the simulation. If the system must be capable of dealing with whatever activation level comes along, and people are limited in their ability to communicate, then the system must have the capacity to generate new relationships when the limit of already-participating dyads is exceeded.

A third assumption has to do with how relationships are selected for activation and how new relationships are formed when needed. In line with the principle of least effort, the system is assumed to have a bias toward activating existing relationships, and creating new ones if necessary in accordance with existing structure. It is easiest for the system to prefer activating dyads who already have perceived relationships, because the fewest startup costs would be associated with that choice. If new relationships are to be created, then it is easier to create them between people who are organized by the focus doing the activating. Foci are sites for the formation of new relationships because they bring people with similar interests into contact. Least easy would be creating relationships between people who have no relationship and are not organized by the focus in question.

In an opposite situation, there may be an oversupply of potential communicating dyads relative to the activation level. For example, think of the case where a focus that organizes a large number of people is triggered to a small level of activation. Perhaps any pair or set of the people could easily communicate enough to dissipate the activation in a short period of time.

In considering which relationships will actually be activated, the assumption is that this selection process is random, and operates within the constraints of the particular relationships in the organization. Other things being equal, stronger relationships are more likely to be reproduced than weaker ones. Therefore, in the simulation relationships are activated by a random draw positively weighted by the strength of the perceived relationship between the people in question.

For the eleven network foci in the model, it is normal for more than one to be activated at any given time. This represents competing demands of the activity system, and there must be some mechanism for allocating attention and efforts to these different demands. The social system gives the most attention to the most activated foci. Accordingly, it allocates communicators to resolve the most activated foci first, the next most activated second, and so on.

The social activation process algorithm starts with data about which people are organized by which focus, and which people have existing perceived relationships with which others, i.e., the perceived communication network. It uses this data in conjunction with output from the model to determine which members become activated.

For a given time step, the algorithm begins by getting activation values from input for each of the eleven foci. It orders the foci according to activation level, and works through the selection process starting with the most activated focus. This ordering insures that preferred relationships according to the selection logic are most likely to be assigned to the most activated foci.

For each focus, the algorithm determines the number of communication units associated with the activation level of the focus; this defines n, the number of dyads who must be picked. It picks those dyads by implementing a three-tiered selection process. First, it extracts from the set of all possible dyads a subset whose members are both organized by the focus and have a non-zero perceived relationship. It then selects dyads from this subset according to a random draw without replacement weighted by the size of the perceived relationships between the dyads.

If there are fewer than n dyads in the first subset, the algorithm goes to the second tier of selection. Here it identifies a subset of all dyads who are organized by the focus but do not have existing relationships, then it chooses randomly from among this subset. If this process does not result in selection of all n dyads, the third tier is to choose randomly from the subset of all pairs that are not eligible for selection in the first two tiers.

Once the pairs are selected, the number of communication units activated for each pair is recorded in an outcome socio-matrix. A vector showing the communication load of each member is also updated. This vector is checked constantly during the three-tier selection process described above. Even if eligible according to the selection criteria, a pair will not be selected if either member is at its communication capacity limit as set in the model parameter. The selection continues until all of the activation in all the foci is dissipated for one time step.

As mentioned above, the focus activation series are generated by the activity model. The model is run once using the hypothetical triggers data, and parameter settings of carryover =0.08 and neighbor influence =0.03. The activation values for each of the eleven foci are rescaled to a range of 0-100.

The matrix represents how people are associated with activities in the store. It is developed using a plausible scenario based on original work at the store. The manager is organized by most or all foci. However, stock personnel are primarily organized by stocking, merchandising, and special events. A head cashier may only be organized by customer service, managing people, and administration, whereas regular cashiers are activated primarily by customer service and special events, and so on. For this test of the simulation, a set of 15 store personnel is created, associated with the various sets of the foci.

The perceived communication relationships matrix is a non-directed, valued socio-matrix representing the strength of the perceived communication relationship between each pair of people in the network. A starting network of links is created by inserting a one in the cell representing a pair if a random draw exceeds a probability parameter.

In describing how activation units relate to communication units, a parameter for the nature of communication units remains abstract and associate communication units with activation in a monotonic fashion. Each communication unit in this simulation is interpreted as a need for communication by a unique dyad during the time step, and additional dyads are required at higher thresholds of activation. For activation between 1 and 25 the simulation requires one communication unit, between 26 and 50 requires two units, between 51-75 requires three units, and 76-100 requires four units. Communication is assumed to be effective and successful in dissipating activity.

There is a parameter that limits the number of units per time period for which a person can be activated. The parameter represents a capacity limit for communication. The parameter is a variable in the simulations, assuming that all people have an equal capacity limit.

The operation of the reticulation function just described governs the activation of existing relationships to dissipate activation in the foci. Its result is observable communication behavior in the organization as the activity gets done. However, this describes only half of the reticulation modality. To complete the picture, a function must be included to account for the influence of the communication behavior on relationships between organization members.

Communication that occurs affects perceived communication relationships, as shown in FIG. 9. Built into this process is a simple view of relational growth and decay. It assumes that when people communicate, their perceived relationship gets stronger, and when people do not communicate, their perceived relationships decay.

The cognition function in the model is very simple. There are three parameters: the increment for a growing relationship, the decrement for a decaying relationship, and the increment for a newly created relationship. The algorithm looks at the outcome matrix from the activation process. If a dyad is activated one or more times, it increments their perceived communication relationship an equal number of times by the value of the growth parameter. If the dyad is not activated, it decrements the perceived relationship by the value of the decay parameter. If the dyad is new, it increments their perceived communication relationship by the value of the new parameter.

The new perceived communication relationship values are used in the next step of the social activation process, along with a new set of activation values from input, these drive the social cognition function, and so on. The simulation proceeds in this fashion for 27 time steps, resulting in dynamic changes in the perceived communication network.

Experimentation with the simulation suggests that decay and capacity parameters have especially important influence on its systemic behavior. Decay determines the rate at which perceived relationships fade away from lack of use. Put another way, it determines the inertia or stability of established relationships. In this simulation, the decay parameters are not set high enough that very strong relationships could quickly die out, so decay has its biggest impact on more marginal relationships.

When decay is high, newly created relationships tend to be more temporary, and weak existing relationships are more likely to disappear. The net effect of this depends on other factors like individual capacity: either it decreases the system's stock of relationships, or generates churn in the sense of creation, extinction, and recreation of temporary relationships. When decay is low, newly created relationships have more permanence. The future structure of the system is more constrained by its present relationships because these existing and more persistent relationships are more likely to be reproduced.

The capacity limit parameter for the activation function is also important in the performance of the simulation. It affects the extent to which the system reproduces old relationships instead of forming new ones. When the capacity parameter is set high, the system reproduces existing relationships. When it does form new relationships, they tend to be between people already organized by the focus involved. Moreover these new relationships are volatile. Stronger existing relationships are more likely to be selected for future activation, so it is easy for newly created relationships to die out in subsequent time steps. The result is a less dense network made up of relationships that are stronger on the average.

When the capacity limit is low, on the other hand, the system tends to produce more new relationships. More of these are between people not already organized by the foci, because with low capacity the relational resources associated with a focus are more quickly consumed. Newly created relationships are slower to die out than when capacity is high because they become eligible for the now more frequent second-tier selection, and are more likely to be reproduced.

Considering relatively high versus low values of decay and capacity, one can discern four different interactions or change processes, listed in Table 2. High decay causes relational volatility, but whether this is widespread depends on individual capacity. Likewise, capacity governs the rate at which new relationships are created, but the structural effect of these depends on their stability as determined by the decay parameter.

TABLE 2
Change processes under different conditions of
decay and capacity

| | High Capacity | Low Capacity |
|---|---|---|
| High | Few new relationships | More new |
| Decay | are created, and if | relationships |
| | created they tend to | created but they |
| | fade out quickly. | tend to die out |
| | | quickly. |
| Low | Few new relationships | More new |
| Decay | are created, and if | relationships are |
| | created tend to be | created, both from |
| | within existing focus | within and without |
| | organization, and | the existing focus |
| | persist/grow. | structure, and they |
| | | tend to persist and |
| | | grow. |

To systematically test the effects of decay and capacity, the effects on network characteristics are examined over multiple runs of the simulation. However the fact that the simulation runs over a finite amount of time requires the introduction of one more variable into the experimental design. The reticulation simulation requires a starting configuration of the network, and attributes of the starting network can have important effects on the outcome of the simulation. Fortunately, the placement of links can be randomized, precluding any systematic prestructuring of the network. But the density of the network is another matter. Assume that the amount of raw material available is going to have a big impact on any structuring process, so it seems unwise to simply generate networks with random numbers of links.

The simulations are run for eight different conditions. For each of these conditions, one combination of high and/or low settings is used for initial density, capacity, and decay. To create the initial perceived communication relationships matrix for each run, the cells are seeded with a one if a random draw between zero and one fell at or below the initial density parameter, and a zero otherwise. Next the network metrics are computed as described below on the initial matrix. The simulation is run through its 27 steps, and recomputed the network metrics. The outcomes are recorded and report below are the average change in the metrics over the 101 runs for each condition.

TABLE 3
Parameter settings for experimental simulation runs

| Parameter | High Setting | Low Setting |
|---|---|---|
| Initial Density | .5 | .1 |
| Capacity | 8 | 2 |
| Decay | .1 | .02 |

| | |
|---|---|
| New | .1 |
| Grow | .3 |

Two metrics are used to measure network attributes. To change its communication network structure, a system has basically two options. It can add or subtract relationships and change their strength, and/or it can rearrange existing relationships into different patterns. Centrality is a common measure of the amount of structure in a network. The measure is group betweenness centrality. This reflects the extent to which particular nodes are prominent in channeling the flow of a resource in the network overall.

Changes in density in each of the eight conditions are shown in Table 4. For low decay, initial density has no effect. The main effect is that low capacity leads to increased density, whereas high capacity seems to show negligible change regardless of density. For high decay, however, the crucial variable is initial density. High initial density is associated with a decrease in density, whereas low initial densities seem to have negligible change regardless of initial density.

TABLE 4
Average change in density over 100 runs of the
simulation under various conditions

| | | Initial | Initial |
|---|---|---|---|
| Decay | Capacity | Density Low | Density High |
| Low | Low | 0.181 | 0.155 |
| | High | 0.049 | 0.025 |
| High | Low | 0.079 | −.201 |
| | High | 0.027 | −.225 |

Changes in the centralization for each of the eight conditions appear in Table 5. Here the situation is somewhat different. For the low decay condition, low capacity leads to decentralization, especially in the case of low initial density. For high decay situations, on the other hand, the higher the density, and to a lesser extent the higher the capacity, the greater the centralization.

TABLE 5
Average change in betweenness over 100 runs of
the simulation under various conditions

| | | Initial | Initial |
|---|---|---|---|
| Decay | Capacity | Density Low | Density High |
| Low | Low | −0.153 | −0.038 |
| | High | 0.051 | −0.006 |
| High | Low | −0.002 | 0.195 |
| | High | 0.086 | 0.261 |

The model is built on the idea that perceived communication relationships are structural resources that an organizational system can activate to generate communication, which dissipates built-up activation. At the same time, manifest communication or lack thereof influences the strength and existence of perceived communication relationships. This creates the possibility of some very complex system dynamics that are hinted at in the results presented here.

Before discussing those, it is important to comment on two limitations of the simulation. First, this is a discrete event simulation that runs for a finite amount of time. The approach treats the events as the most important phenomena. Effects of the communicators and their internal mechanisms are minimized. The finite length of the simulation also forces establishment of an initial density condition, whereas in reality density is more of a continuous property of the organization's network. The scope of findings here is therefore limited to how reticulation might operate in mundane circumstances over short periods, though some hints as to cycles or dynamics may exist in a systems dynamics framework.

A second limitation is that this simulation treats the activity system as an external input, the source of which is unaffected by goings-on in the reticulation modality. By the assumptions of reticulation theory these modalities are in fact interdependent. In particular, the activation simulation has a dissipation rate parameter, essentially the rate at which activation in an activity focus is dissipated. Since communication is the primary vehicle by which activity is dissipated, there would be a connection between the communication generated in the reticulation simulation, and the dissipation rate in the activation simulation. This means that findings here are further limited to cases where communication does in fact maintain dissipation rates that keep the activation system in homeostasis. To be sure, it is unlikely that a time-domain simulation is the best choice for integrating the two modalities. A systems dynamics approach would really be better suited to exploring the phase spaces of such complex processes.

Those caveats stated, the simulation does yield some interesting findings. A clear one is that decay is the most important variable in the reticulation process as simulated here. The biggest differences in network attributes are associated with this variable. In low decay situations, when relationships are more stable, the system increases its density and decentralizes its network if individual capacity is low. Thus low relational decay rates and low individual capacity lead to an increase in system level capacity (a network with more links) and structural differentiation. In high decay situations, where relationships are less stable, high density networks become less dense. They also become more centralized, especially in cases of high individual capacity. Thus high relational decay rates lead to a decrease in system level capacity and structural integration.

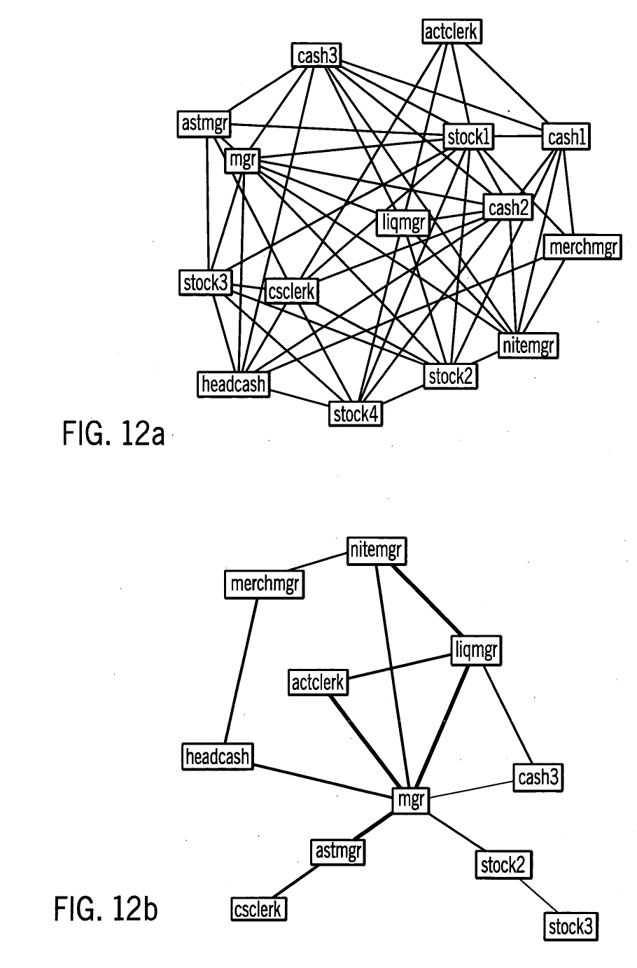

The relationships tend to die out quickly. When the network is in a high density condition, high decay results in pruning of the network, probably down to some optimal level are the simulation to be run continuously. In these conditions of excess relational resources, the system tends to renew links that are already organized by activity foci. To the extent that links are structured in terms of the differential assignment to the foci, then this structure will tend to be transferred to the network. Activation is focusing the reticulation process on the relationships associated with the foci. This is especially true for high individual capacity, because in this condition there is less of a chance that a focus” relational resources will be exhausted in any given circumstances of activation. FIGS. 12a-12b shows before and after networks for an example run of the simulation under high decay, high initial density, and high capacity.

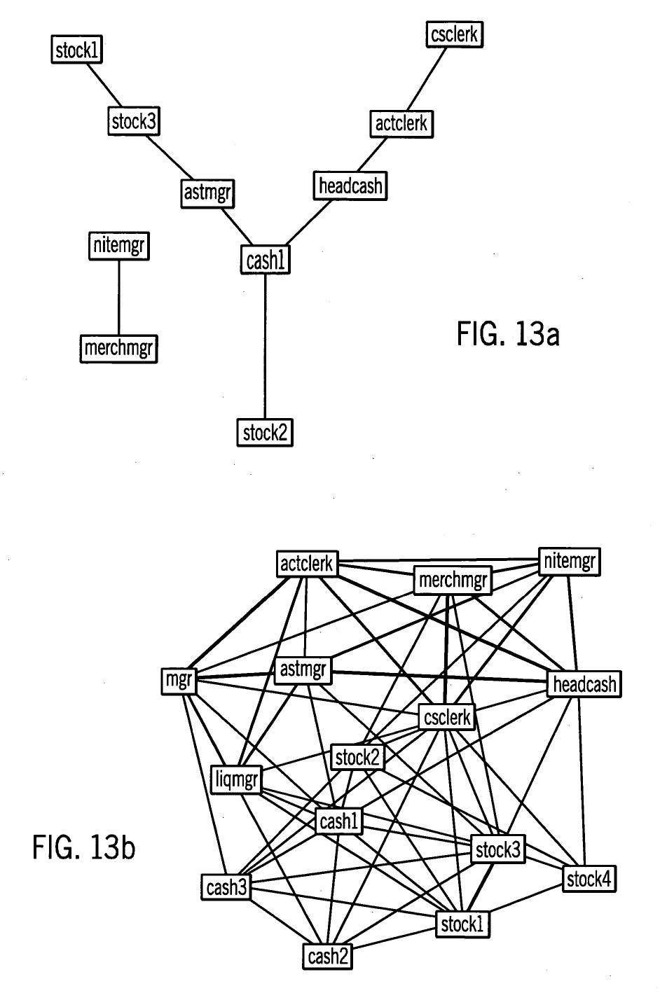

In the low decay situation, in contrast, relationships are more stable. Capacity becomes the crucial variable. Notwithstanding the more stable relationships, if capacity is low then relational resources associated with the foci are easily consumed. According to the logic of the simulation, the system must create new relationships to take up the slack. Because relational resources associated with the foci are exhausted, there is little choice but to create new relationships outside the focus structure. In contrast to the high decay situation, there are fewer opportunities for the focus structure to guide reticulation, resulting in decentralization. FIGS. 13a-13b show before and after networks for an example run of the simulation under low decay, low capacity settings.

One finding is that between these two conditions, there seem to be no systematic differences in network outcomes. This is because the simulation provides counterbalancing effects. For example, in the low decay situation, high individual capacity preempts the need to create new relationships. When relationships are reproduced, they are more likely to be reproduced within the focus structure. This prevents the decentralizing effects associated with low decay plus low capacity. Likewise in the high decay situation, if network density is not high then there is no basis for a pruning process that eliminates nonfocus-related relationships in favor of focus-related ones. Furthermore, if individuals have low rather than high capacity, conditions also disfavor reproduction of focus-related links.

The reticulation has three modes, as summarized in FIG. 14. For a continuous simulation, the reticulation process swings back and forth along this line, re-structuring at the right end when the network becomes too tightly coupled and unstable, and de-structuring with unfocused growth when activation starts to tax the capacity of the system. The reticulation process is stable at its limits, and that a relatively stable dynamic is possible in between them.

The findings of the model suggest that growth in unstable relationships eventually causes reactive structural integration, and stable relationships that lose their capacity for communication result in structural differentiation.

The decay of relationships is a crucial part of the process. Future efforts should try to develop a more realistic view of relational decay than the simple, linear processed assumed here. Relationships of longer tenure are undoubtedly more resistant to decay. Also, whereas some, perhaps many, organizational relationships fade away as assumed in this simulation, it is also quite common for relationships to burn out in a precipitous decline or falling-out. A more realistic simulation would allow for this kind of decay as well.

There is a suggestion in these results of a dynamic wherein the communication/activity system has stable reproduction that is limited by growth and decentralization at one extreme, and pruning and centralization at the other. The pruning and centralization is reminiscent of a complexity cascade or avalanche, where a system becomes too tightly coupled and interdependent, and collapses on itself. This possibility underscores the importance of using continuous models for further simulation of reticulation dynamics.

The results suggest that communication and activity systems are self-organizing. Perceived network structuring need not result from personal interests or intentions to control or dominate others. Structure is introduced in the perceived network merely because communication is induced by focused activity. To the extent that there is a preference for having intra-focus members do focus-related activities, then activation of a focus reproduces and strengthens relationships between its members. Those who are organized by more than one focus will tend to assume central positions in the network because they act as bridges between different groups of focus-related members. If this insight is correct, then network centralization and structuring is inevitable in any organization where activities are differentiated and members are differentially associated with the activities.

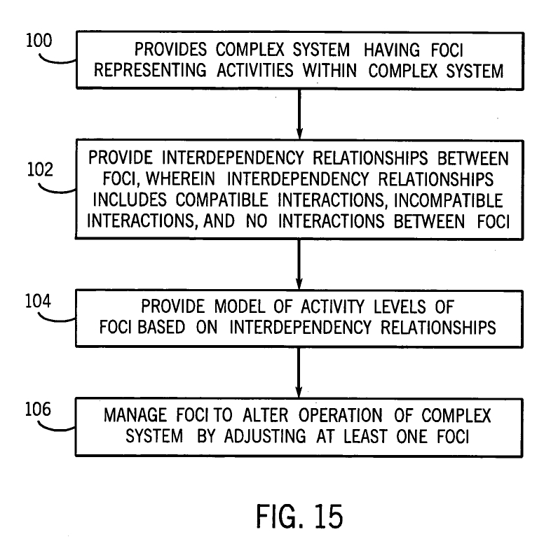

The process of modeling complex systems is shown in FIG. 15. Step 100 provides a complex system having foci representing activities within the complex system. The foci can represent functions within a commercial business. Step 102 provides interdependency relationships between the foci. The interdependency relationships includes compatible interactions, incompatible interactions between first and second ones of the foci, and no interactions between the foci. The interdependency relationships are represented as links between the foci, which are coded to indicate magnitude and sign of each interdependency relationships. Step 104 provides a model of activity levels of the foci based on the interdependency relationships. The model is defined in part by A_{f,t-0}=E_{f,t-0}+c_{f}A_{f,t-1}−n_{f}O_{f,t-1}+ε, and can be represented graphically as activation levels over time. Step 106 manages the foci to alter the operation of the complex system by adjusting at least one of the foci.

While one or more embodiments of the present invention have been illustrated in detail, the skilled artisan will appreciate that modifications and adaptations to those embodiments may be made without departing from the scope of the present invention as set forth in the following claims.

What is claimed is:

1. A computer implemented method of modeling a complex system, comprising:
providing a complex system having foci representing activities within the complex system;
providing interdependency relationships between the foci;
providing a model of activity levels of the foci based on the interdependency relationships; and
managing the foci to alter the operation of the complex system.

2. The computer implemented method of claim 1, wherein the foci represent functions within a commercial business.

3. The computer implemented method of claim 1, wherein the interdependency relationships includes a compatible interaction between first and second ones of the foci.

4. The computer implemented method of claim 1, wherein the interdependency relationships includes an incompatible interaction between first and second ones of the foci.

5. The computer implemented method of claim 1, wherein the interdependency relationships includes no interaction between first and second ones of the foci.

6. The computer implemented method of claim 1, wherein the interdependency relationships are represented as links between the foci.

7. The computer implemented method of claim 6, wherein the links are coded to indicate magnitude and sign of each interdependency relationship.

8. The computer implemented method of claim 1, wherein the model is represented graphically as activation levels over time.

9. The computer implemented method of claim 1, wherein the model is defined in part by A_{f,t-0}=E_{f,t-0}+c_{f}A_{f,t-1}−n_{f}O_{f,t-1}+ε.

10. The computer implemented method of claim 1, wherein the model is managed by adjusting at least one of the foci.

11. A method of using a model of a complex system, comprising:
providing a model of a complex system having foci representing activities within the complex system, wherein the model is based on interdependency relationships of the foci;
providing activation triggering events to exercise the foci; and
managing reaction of the foci to the activation triggering events to alter the operation of the complex system.

12. The method of claim 11, wherein the interdependency relationships includes a compatible interaction between first and second ones of the foci.

13. The computer implemented method of claim 11, wherein the interdependency relationships includes an incompatible interaction between first and second ones of the foci.

14. The method of claim 11, wherein the interdependency relationships includes no interaction between first and second ones of the foci.

15. The method of claim 11, wherein the operation of the complex system is altered by reducing activation dissipation.

16. The method of claim 11, wherein the operation of the complex system is altered by increasing activation dissipation.

17. The method of claim 16, wherein the links are coded to indicate magnitude and sign of each interdependency relationship.

18. The method of claim 11, wherein the model is represented graphically as activation levels over time.

19. The method of claim 11, wherein the model is represented graphically as activation levels over time.

20. A computer program product usable with a programmable computer processor having a computer readable program code embodied therein, comprising:
computer readable program code which provides a complex system having foci representing activities within the complex system;
computer readable program code which provides interdependency relationships between the foci;
computer readable program code which provides a model of activity levels of the foci based on the interdependency relationships; and
computer readable program code which manages the foci to alter the operation of the complex system.

21. The computer program product of claim 20, wherein the interdependency relationships includes a compatible interaction between first and second ones of the foci.

22. The computer program product of claim 20, wherein the interdependency relationships includes an incompatible interaction between first and second ones of the foci.

23. The computer program product of claim 20, wherein the operation of the complex system is altered by reducing activation dissipation.

24. The computer program product of claim 20, wherein the operation of the complex system is altered by increasing activation dissipation.

25. A computer system for providing a non-parametric model, comprising:
means for providing a model of a complex system having foci representing activities within the complex system, wherein the model is based on interdependency relationships of the foci;
means for providing activation triggering events to exercise the foci; and
means for managing reaction of the foci to the activation triggering events to alter the operation of the complex system.

26. The computer system of claim 25, wherein the interdependency relationships includes a compatible interaction between first and second ones of the foci.

27. The computer system of claim 25, wherein the interdependency relationships includes an incompatible interaction between first and second ones of the foci.

28. The computer system of claim 25, wherein the operation of the complex system is altered by reducing activation dissipation.

29. The computer system of claim 25, wherein the operation of the complex system is altered by increasing activation dissipation.
